(19) United States
(12) Patent Application Publication
(10) Pub. No.: US 2005/0236897 A1
(43) Pub. Date: Oct. 27, 2005

(54) Tone wheel and wheel slop detecting system using tone wheel

(76) Inventor: Young-Suk Jung, Ulsan Metropolitan City (KR)

Correspondence Address: MORGAN, LEWIS & BOCKIUS LLP (SF), 2 PALO ALTO SQUARE, PALO ALTO, CA, 94306, US

(21) Appl. No.: 11/116,683

(22) Filed: Apr. 27, 2005

(30) Foreign Application Priority Data
Apr. 27, 2004 (KR) 10-2004-0029023

(51) Int. Cl. B60T 8/66

(52) U.S. Cl. 303/166

(57) ABSTRACT

A wheel slip detecting system that operates an anti-lock brake system by detecting the wheel slip includes a tone wheel comprising a metallic ring body, perforations and imperforations that are formed at a constant interval on a flat plate of the ring body, and a flange that is extendedly formed by bending the circumferential surface of the ring body. A detector detects the perforations and the imperforations of the wheel when the tone wheel rotates. A controller controls the operation of the anti-lock brake system on the basis of the detected result of the detector. The tone wheel, thus constructed, is protected from damage upon an exterior impact while effectively reducing in manufacturing costs and weight thereof.

### CROSS-REFERENCE TO RELATED APPLICATIONS

The present application is based on, and claims priority from, Korean Application Serial Number 10-2004-0029023, filed on Apr. 27, 2004, the disclosure of which is hereby incorporated by reference herein in its entirety.

### FIELD OF THE INVENTION

The present invention generally relates to anti-lock braking systems and specifically to detecting wheel slippage.

### BACKGROUND OF THE INVENTION

Generally, an anti-lock brake system prevents wheel lockup during braking on a slippery road, and it maintains a direction stability of the vehicle via electronic control. When a vehicle makes a sudden stop on an icy or wet road, the vehicle tends to skid due to a loss of traction and wheel lockup. If the wheel stops rotating by being locked, the wheel loses directionality. Therefore, the wheel should continuously rotate right before the lockup.

In order to prevent wheel lockup, vehicle speed and wheel rotation are detected. If the deceleration rate of the wheel rotation is greater than the deceleration rate of the vehicle speed, the hydraulic pressure applied to a wheel cylinder should be decreased. If the wheel is not locked by the above system, the braking distance is shortened. Thus, the wheel slip should be detected accurately to prevent wheel skid and to execute precise and short braking the anti-lock brake system.

The anti-lock brake system engages when a vehicle wheel slip is detected. A wheel slip detecting system detects the wheel slip by using a tone wheel made of a sintered alloy of a soft magnetic material. During a sudden stop, the slip (lockup) of the wheel is transmitted to an Electronic Control Unit (ECU) to enable vehicle steering, thereby preventing major accidents in advance by promptly coping against hazardous situations.

However, there is a drawback in that the sintered alloy tone wheel used in the conventional wheel slip detecting systems is brittle. Another drawback is that the tone wheel may be damaged by impurities on the road or by impurities inserted into the tooth-shaped portions of the tone wheel. Furthermore, all raw materials of the tone wheel are expensive, thus increasing manufacturing costs.

### SUMMARY OF THE INVENTION

Embodiments of the present invention provide a tone wheel that is protected from damage upon an exterior impact and effectively reduce manufacturing costs and weight thereof. The present invention further provides a tone wheel having a structure functioning as a dust cover.

A wheel slip detecting system that operates an anti-lock brake system by detecting a wheel slip comprises a tone wheel including a metallic ring body, perforations and imperforations that are formed at a constant interval on a flat plate of the ring body, and a flange that is extendedly formed by bending the circumferential surface of the ring body. A detector detects the perforations and the imperforations during rotation of the tone wheel. A controller controls the operation of the anti-lock brake system on the basis of the detected result of the detector.

The tone wheel is preferably made of a rolled steel plate and manufactured by a press method. The detector is preferably a magnetic field sensor and may use a sensor constituted by a photodiode and photo transistor.

A tone wheel according to another embodiment of the present invention is installed on a wheel to detect the rotational difference of the wheel. The tone wheel includes a ring body made of a metallic material, perforations and imperforations formed at a constant interval along the periphery of the ring body, and a flange extendedly formed by bending a flat plate of the ring body along the periphery thereof.

### BRIEF DESCRIPTION OF THE DRAWINGS

FIG. 1 is a perspective view of a drive shaft mounted with a tone wheel according to an embodiment of the present invention; and

FIG. 2 is a block diagram of a wheel slip detecting system using the tone wheel of FIG. 1.

### DETAILED DESCRIPTION OF THE PREFERRED EMBODIMENTS

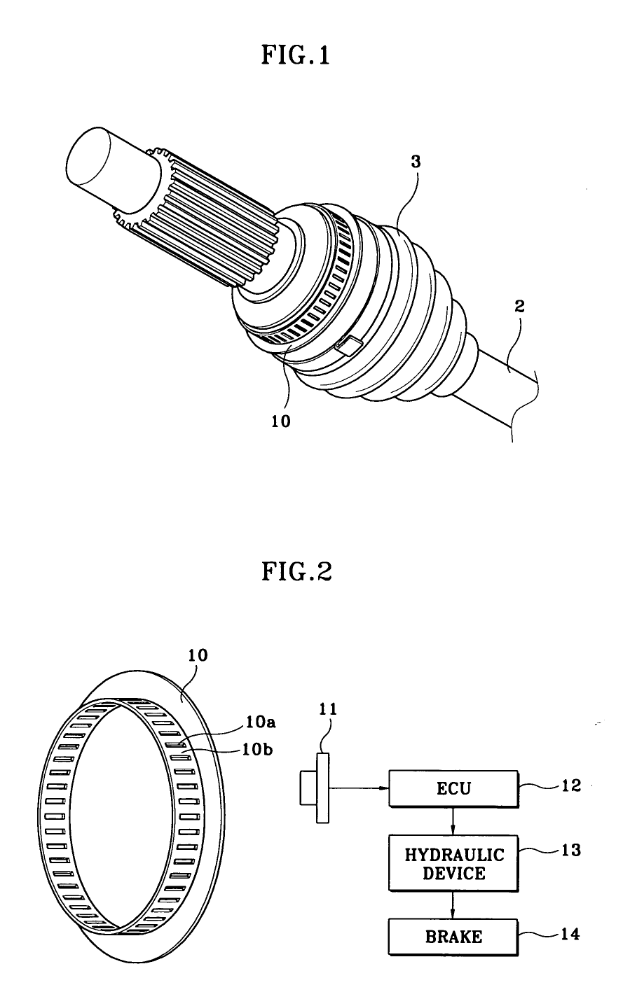

Referring to FIG. 1, a tone wheel 10 having a metallic ring shape with a predetermined thickness according to an embodiment of the present invention is mounted on a joint 3 of a drive shaft 2 or a hub (not shown). The tone wheel 10 includes perforations 10a, imperforations 10b, and a flange. The perforations 10a are cut-off portions on a flat plate at a constant interval along the periphery of the ring. The imperforations 10b are formed between the perforations. The flange is extendedly formed by bending the flat plate along the periphery of the tone wheel to prevent impurities, just like a dust cover.

The tone wheel 10 is manufactured by a press method using a rolled steel plate. The rolled steel plate having a high ductility prevents abnormal operation of the tone wheel, conventionally made of a sintered alloy of a soft magnetic material, due to damage or impurities. Thus, the tone wheel 10 of the rolled steel plate can precisely detect the wheel slip. A warning light from the anti-lock braking system conventionally illuminated when damaged by impurities of the roadway as the vehicle travels across a terrain is also prevented from illuminated.

In reference to FIG. 2, a wheel slip detecting system includes a tone wheel 10 mounted on the drive shaft 2 or hub (not shown). A wheel sensor 11 detects the perforations 10a and imperforations 10b during the rotation of the tone wheel 10 and generates a different sine wave electrical signal. An Electronic Control Unit 12 receives the sine wave electrical signal generated from the wheel sensor 11 and detects a wheel slip. A hydraulic device 13 controls a brake 14 in response to the control of the ECU 12.

The wheel sensor 11 is preferably a magnetic field sensor, which detects the inductive electric power generated by the perforations 10a and imperforations 10b of the tone wheel 10. Alternatively, a photodiode and photo transistor or the like may be used to determine the rotational state of the tone wheel 10 by detecting the perforations 10a and imperforations 10b.

The tone wheel in the present invention is a ring member formed with the perforations and imperforations. The wheel sensor detects the perforations and imperforations to count the number of rotations of the tone wheel. Unlike the conventional tone wheel made of the sinter alloy, the rolled steel plate used in one embodiment of the present invention requires less process steps, which reduces the manufacturing costs. Additionally, the conventional tone wheel of the sintered powder alloy makes the formation difficult to be thin due to its hardness. However, the rolled steel plate of the present invention can be formed in various thickness, thereby greatly reducing the weight thereof. Further, the conventional sintered tone wheel is equipped with a supplemental dust cover or is deformed in shape to protect the tone wheel or hub bearing from impurities on the road. Whereas, the tone wheel with the rolled steel plate is integrally formed with a flange to function as a dust cover.

As apparent from the foregoing, there is an advantage in that the tone wheel is protected from damage upon an exterior impact and is effectively reduced in manufacturing costs and weight thereof. The tone wheel of this embodiment of the present invention is further configured as a dust cover.

While the foregoing description represent various embodiments of the present invention, it will be appreciated that the foregoing description should not be deemed limiting since additions, variations, modifications and substitutions may be made without departing from the spirit and scope of the present invention. It will be clear to one of skill in the art that the present invention may be embodied in other forms, structures, arrangements, and proportions and may use other elements, materials and components. The present disclosed embodiments are, therefore, to be considered in all respects as illustrative and not restrictive, the scope of the invention being indicated by the appended claims and not limited to the foregoing description.

1. A wheel slip detecting system that operates an anti-lock brake system by detecting a wheel slip, comprising:
a tone wheel including a metallic ring body, perforations and imperforations formed at a predetermined interval on a flat plate of said ring body, and a flange extendedly formed by bending a circumferential surface of said ring body;
a detector that detects said perforations and said imperforations during rotation of said tone wheel; and
a controller that controls the operation of said anti-lock brake system on the basis of the detected result of said detector.

2. The system as defined in claim 1, wherein said tone wheel is made of a rolled steel plate.

3. The system as defined in claim 1, wherein said detector includes a magnetic field sensor.

4. The system of claim 1, wherein said tone wheel is made of a magnetic material.

5. The system of claim 1, wherein said predetermined interval is a constant interval.

6. A tone wheel installed on a wheel to detect the rotational difference of said wheel, comprising:
a ring body made of a metallic material;
perforations and imperforations formed at a predetermined interval on said ring body along a periphery of said ring body; and
a flange extendedly formed by bending a flat plate of said ring body along the periphery thereof.

7. The tone wheel of claim 6, wherein said perforation and said imperforation are magnetic.

8. The tone wheel of claim 6, wherein said metallic material of said ring body is magnetic.

9. The tone wheel of claim 6, wherein said metallic material is made of rolled steel plates.

10. The tone wheel of claim 6, wherein said predetermined interval is a constant interval.
